(19) United States
(12) Patent Application Publication
(10) Pub. No.: US 2022/0339643 A1
(43) Pub. Date: Oct. 27, 2022

(54) SWING ROTOR ASSEMBLY FOR CENTRIFUGE

(71) Applicant: MIRACELL CO., LTD., Seoul (KR)

(72) Inventor: Hyun Soon SHIN, Seoul (KR)

(73) Assignee: MIRACELL CO., LTD., Seoul (KR)

(21) Appl. No.: 17/762,700

(22) PCT Filed: Nov. 4, 2020
(86) PCT No.: PCT/KR2020/015338

§ 371 Date: Mar. 22, 2022

(30) Foreign Application Priority Data
Nov. 5, 2019 (KR) 10-2019-0140495

(51) Int. Cl. B04B 15/00; B04B 5/04; B04B 9/02

(52) U.S. Cl. CPC B04B 15/00; B04B 5/0421; B04B 9/02

(57) ABSTRACT

A swing rotor assembly for a centrifuge. The swing rotor assembly includes a driving unit including a motor, a mounting cap on the motor, and a transmission charging module on the mounting cap to wirelessly charge the battery; a rotor header including a case in which U-shaped curved portions are formed for mounting a bucket while being mounted and rotated on a motor driving shaft, an angle maintaining unit mounted inside the case to control an angle of the bucket and discharge a centrifuged sample, a battery mounted inside the case to drive the angle maintaining unit, a reception charging module on the case to wirelessly charge the battery, and a rotation shaft unit inside the case and rotatably supported at both sides of the bucket; and a bucket on the rotation shaft unit and rotating up and down by a centrifugal force while rotating together with the rotor header.

### TECHNICAL FIELD

The present invention relates to a swing rotor assembly for a centrifuge, and more particularly, to a swing rotor assembly for a centrifuge which is installed inside a centrifuge to centrifuge samples such as blood or bone marrow and provided with an angle maintaining unit which maintains an angle of a bucket so as to efficiently discharging centrifuged samples (blood, bone marrow, etc.) and a battery for driving the angle maintaining unit.

### BACKGROUND ART

When a suspension with a floating material is left, high-density materials slowly sink to the bottom under the influence of gravity and low-density materials slowly move to the upper layer, and this process is called sediment.

As such, when materials with different densities are mixed, the sediment occurs, and the mixture may be separated over time according to a density difference. Since the density difference between mixtures increases as the gravity, a force for separating the mixture, increases, the sediment may be accelerated by artificially increasing the gravity.

In other words, the sediment may be easily accelerated using a centrifugal force instead of the gravity, and this process is called centrifugation. The centrifuge is a machine used to separate, purify, and concentrate materials with different components or specific gravity using a principle of centrifugation, and may be divided into medical use, wastewater treatment, uranium enrichment, production, and experimental use depending on the purpose of use.

In particular, the medical centrifuge is used for separating components for analysis of blood, urine, saliva, and the like. For example, platelet-rich plasma (PRP) obtained by centrifugation of bone marrow or blood refers to a highly enrichment plasma component in which the platelet is richer than normal bone marrow or blood. For example, the PRP is injected into a damaged area such as ligament and cartilage to be used for reconstructing the damaged area and uses own bone marrow or blood, so that there are no side effects and the treatment effect is quick.

Based on this technical idea, in Korean Patent Registration No. 10-1387433, there is disclosed a centrifugal separator and a bucket capable of using both functions of a swing rotor and an angle rotor so as to implement the function of the angle rotor in the swing rotor by replacing an appropriate bucket without replacing the entire rotor.

According to the related art, it is theoretically possible to increase a treatment capacity by forming a plurality of accommodating units in the bucket, to provide a bucket corresponding to various storage containers by varying the size and shape of the accommodating unit in the bucket, and to simultaneously perform separation by a swing rotor and separation by an angle rotor even if one swing rotor is subjected to a single centrifugation process according to the features.

However, the centrifugation of the sample may be easy according to the advantages described so far, but in order to inject the separated components into another space (chamber) after centrifugation inside the sample container, the sample should be discharged while maintaining an inclined state at a predetermined angle, but there is a problem in that it is not easy to maintain an angle for discharging the sample.

### DISCLOSURE

### Technical Problem

An object of the present invention is to solve the problems and to provide a swing rotor assembly for a centrifuge by having an angle maintaining unit to maintain an inclined angle of a bucket inclined to be close to horizontal by a centrifugal force when a rotor is rotated to fix an angle of a decanting kit accommodated in the bucket as it is, so that a sample contained in the decanting kit may be efficiently separated.

### Technical Solution

According to an aspect of the present invention, there is provided a swing rotor assembly for a centrifuge that is mounted and rotated inside a housing of the centrifuge, wherein the swing rotor assembly includes a driving unit configured by a motor having a driving shaft, a mounting cap mounted on the upper portion of the motor and provided with a flange at the lower end, and a transmission charging module fixed on the mounting cap to wirelessly charge the battery; a rotor header including a case in which U-shaped curved portions are formed on both sides for mounting a bucket while being mounted and rotated on a motor driving shaft, an angle maintaining unit which is mounted inside the case to control an angle of the bucket and discharge a centrifuged sample, a battery mounted inside the case to drive the angle maintaining unit, a reception charging module mounted on the bottom of the case to wirelessly charge the battery, and a rotation shaft unit mounted inside the case and rotatably supported at both sides of the bucket; and a bucket mounted on the rotation shaft unit and rotating up and down by a centrifugal force while rotating together with the rotor header.

The angle maintaining unit may be configured by a first solenoid valve having a front-rear movement valve shaft that moves forward and backward to fix the position of the bucket so that the bucket is maintained to be inclined at a predetermined angle by a centrifugal force, and a second solenoid valve having a left-right movement valve shaft to fix the valve shaft of the first solenoid to the rear side so as to prevent malfunction or sudden backward of the first solenoid valve.

The rotation shaft unit may be configured by a pair of rotation shaft supports mounted inside the case, a rotation shaft supported by the pair of rotation shaft supports, a pipe extending rotation shaft formed between the pair of supports by extending the rotation shaft, an angle limiting groove formed on the pipe extending rotation shaft to limit the bucket at a constant rotational angle, and a stopper formed below the angle limiting groove to limit the rotational angle of the angle limiting groove.

A power adapter through hole may be further formed above the case, and a power adapter connector into which an adapter is inserted through the power adapter through hole and mounted may be further formed inside the case.

A light transmission hole may be further formed above the case, and an LED indicator for checking whether power is connected and whether power is charged may be further provided inside the case to check whether the power is connected or the power is charged through a light source emitted through the light transmission hole.

The transmission charging module and the reception charging module may be wirelessly connected to each other, so that an induced electromotive force is transmitted from the transmission charging module to the reception charging module to be charged.

### Advantageous Effects

According to the present invention, since the angle may be maintained by the angle maintaining unit provided in the rotor header in separating the components of the sample according to the horizontal rotation of the rotor header, the swing rotor assembly for the centrifuge has an advantage that it is easy to separate the sample from which the components are separated while the rotor header stops rotating.

In addition, since the angle is maintained at a constant angle, the swing rotor assembly for the centrifuge of the present invention has an advantage of increasing the separation efficiency of a sample separated by centrifugation.

In addition, since the swing rotor assembly for a centrifuge of the present invention includes a contactless wireless charging module, the swing rotor assembly for the centrifuge of the present invention has an advantage that the battery can be charged regardless of whether the centrifuge is used or not.

In addition, since the battery is always charged by the charging device, the swing rotor assembly for the centrifugal separator of the present invention has an effect of preventing the malfunction of the angle maintaining unit due to insufficient power of the battery for driving the angle maintaining unit.

In addition, since the second solenoid valve may prevent the malfunction of the first solenoid valve even if the malfunction of the first solenoid valve occurs, the swing rotor assembly for the centrifugal separator of the present invention has an advantage of increasing the centrifugation efficiency.

### DESCRIPTION OF DRAWINGS

FIG. 1 is a perspective view of a swing rotor assembly for a centrifuge according to the present invention.

FIG. 2 is a perspective view of a state in which an upper cover of the swing rotor assembly for the centrifuge according to the present invention is removed.

FIG. 3 is an exploded perspective view of the swing rotor assembly for the centrifuge according to the present invention.

FIG. 4 is an exploded perspective view viewed from a lower side of the swing rotor assembly for the centrifuge according to the present invention.

FIG. 5 is a plan view of the swing rotor assembly for the centrifuge according to the present invention.

FIG. 6 is an exploded perspective view of a bucket and a rotation shaft part according to the present invention.

FIG. 7 is an enlarged perspective view of a rotation shaft part and a first solenoid valve and a second solenoid valve according to the present invention.

FIG. 8 is an operational view of the first solenoid valve and the second solenoid valve of FIG. 7.

FIG. 9 is a side view illustrating separating a sample while the bucket is fixed according to the present invention.

FIG. 10 is a perspective view of a centrifuge mounted with the swing rotor assembly according to the present invention.

### BEST MODE FOR THE INVENTION

An best aspect of the present invention provides a swing rotor assembly for a centrifuge that is mounted and rotated inside a housing of the centrifuge, wherein the swing rotor assembly includes a driving unit configured by a motor having a driving shaft, a mounting cap mounted on the upper portion of the motor and provided with a flange at the lower end, and a transmission charging module fixed on the mounting cap to wirelessly charge the battery; a rotor header including a case in which U-shaped curved portions are formed on both sides for mounting a bucket while being mounted and rotated on a motor driving shaft, an angle maintaining unit which is mounted inside the case to control an angle of the bucket and discharge a centrifuged sample, a battery mounted inside the case to drive the angle maintaining unit, a reception charging module mounted on the bottom of the case to wirelessly charge the battery, and a rotation shaft unit mounted inside the case and rotatably supported at both sides of the bucket; and a bucket mounted on the rotation shaft unit and rotating up and down by a centrifugal force while rotating together with the rotor header.

### Modes for the Invention

Hereinafter, preferred embodiments of the present invention will be described in detail with reference to the accompanying drawings to the extent that a person with ordinary skill in the art to which the invention pertain is able to easily implement the present invention. First, when reference numerals refer to components of each drawing, it is to be noted that although the same components are illustrated in different drawings, the same components are denoted by the same reference numerals as possible. In the description of the present invention, a detailed explanation of related known configurations or functions will be omitted when it is determined to obscure the subject matter of the present invention.

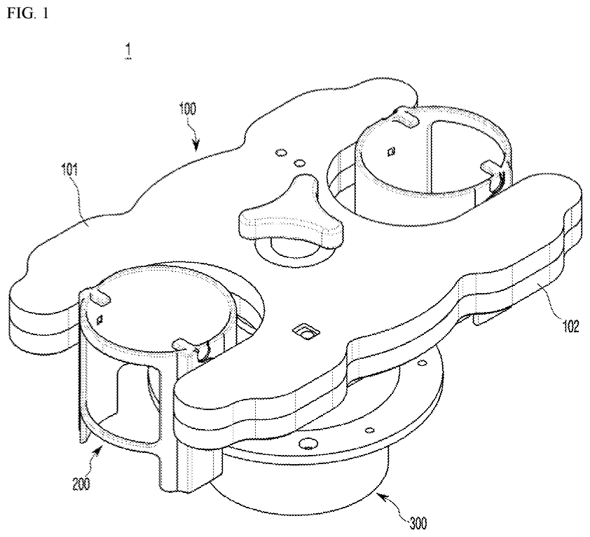

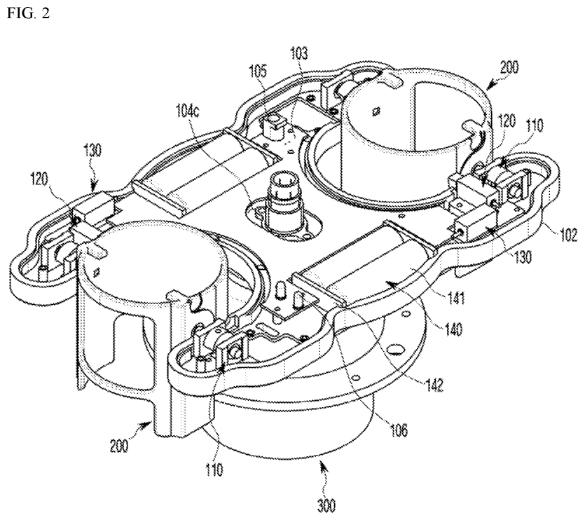

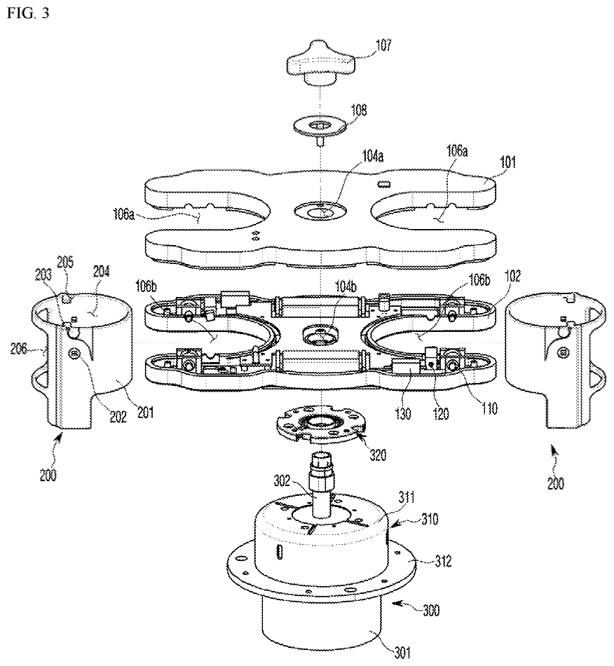

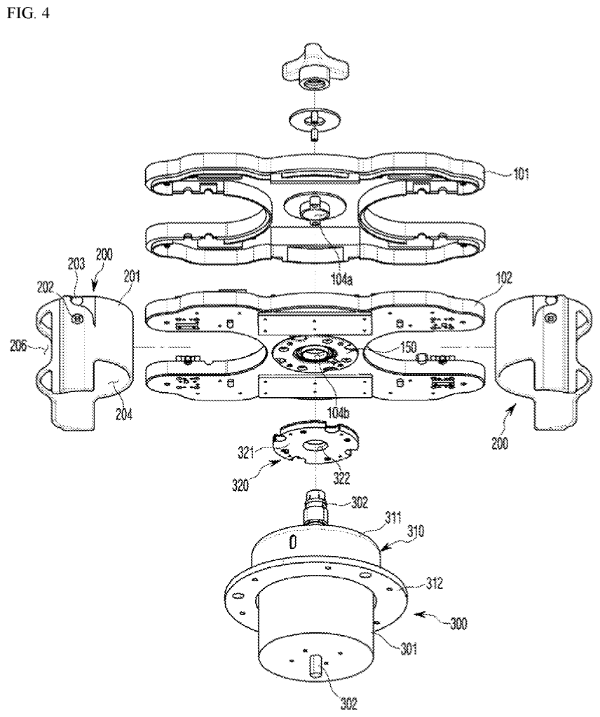

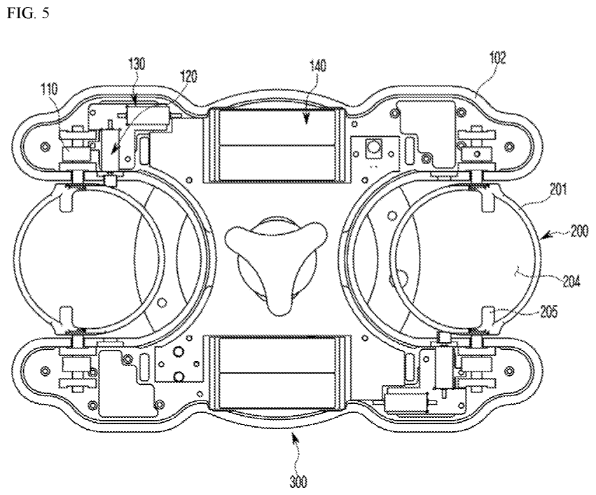

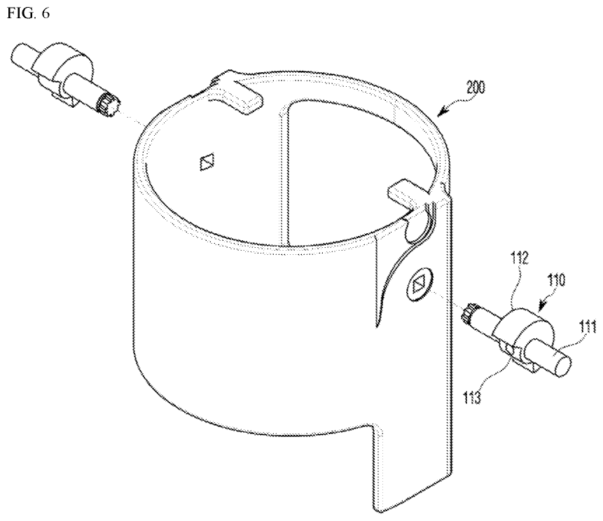

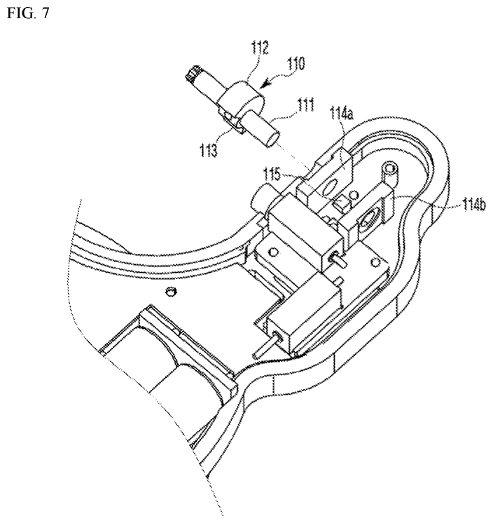

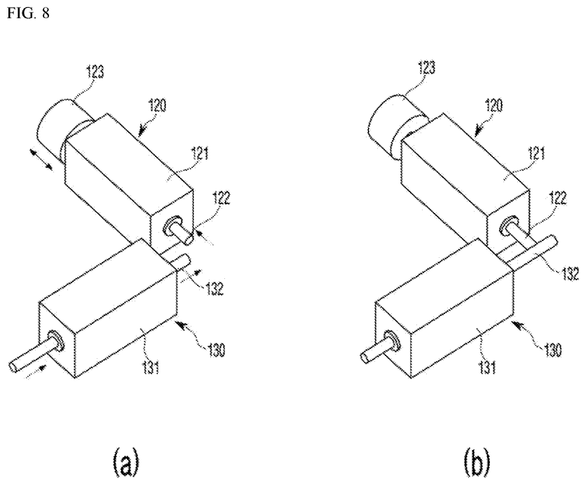

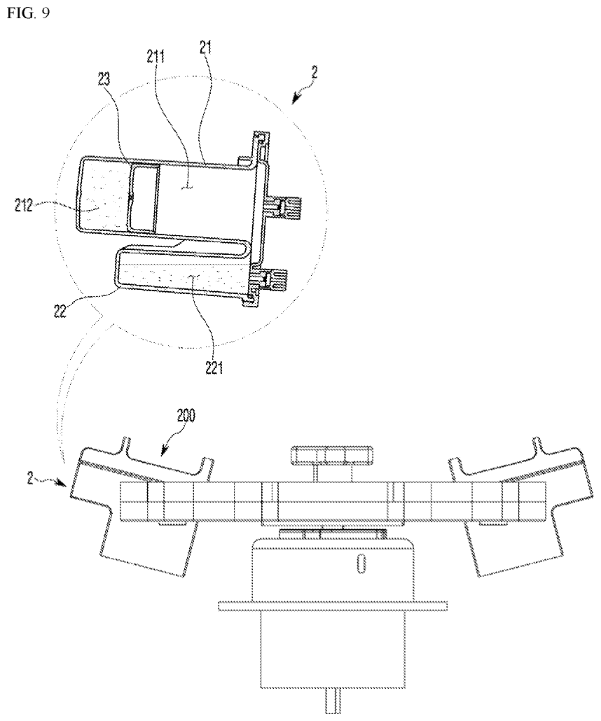

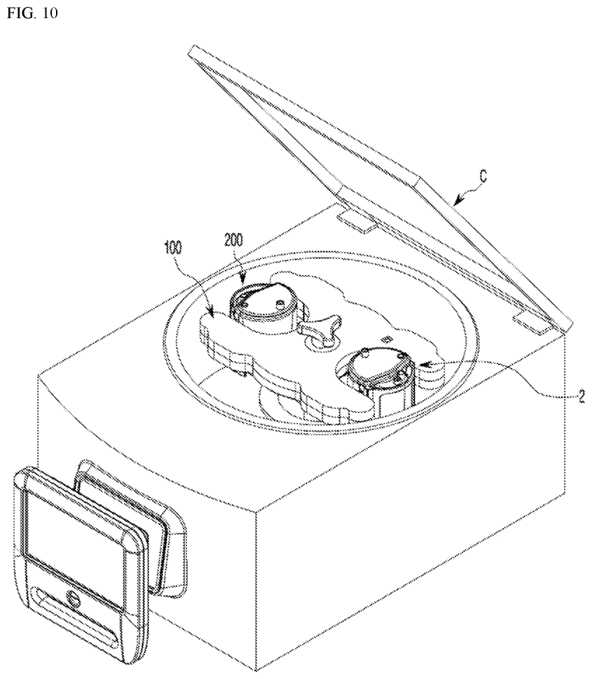

FIG. 1 is a perspective view of a swing rotor assembly for a centrifuge according to the present invention, FIG. 2 is a perspective view of a state in which an upper cover of the swing rotor assembly for the centrifuge according to the present invention is removed, FIG. 3 is an exploded perspective view of the swing rotor assembly for the centrifuge according to the present invention, FIG. 4 is an exploded perspective view viewed from a lower side of the swing rotor assembly for the centrifuge according to the present invention, FIG. 5 is a plan view of the swing rotor assembly for the centrifuge according to the present invention, FIG. 6 is an exploded perspective view of a bucket and a rotation shaft part according to the present invention, FIG. 7 is an enlarged perspective view of a rotation shaft part and a first solenoid valve and a second solenoid valve according to the present invention, FIG. 8 is an operational view of the first solenoid valve and the second solenoid valve of FIG. 7, FIG. 9 is a side view illustrating separating a sample while the bucket is fixed according to the present invention, and FIG. 10 is a perspective view of a centrifuge mounted with the swing rotor assembly according to the present invention.

As illustrated in FIGS. 1 and 2, a swing rotor assembly 1 for a centrifuge according to the present invention is configured by a rotor header 100 that rotates horizontally for a rotating movement of a plurality of buckets 200 in which decanting kits 2 containing a sample are accommodated, respectively, a driving unit 300 that rotates so that the rotor header 100 may be rotated when the centrifuge is operated while connected to the rotor header 100, and a bucket 200 which is mounted on the rotor header 100 and inserted with the decanting kit 2.

The rotor header 100 is a centrifugal rotor that generates a centrifugal force for separation of sample components such as blood or bone marrow contained in the decanting kit 2, and one or more of the plurality of buckets 200 capable of individually receiving and mounting the decanting kit 2 containing an appropriate amount of a liquid sample subject to component separation are shaft-coupled to the rotor header 100 by a driving shaft 302. The rotor header 100 is configured by a case 101 including an upper case 101a and a lower case 101b, a battery 140 mounted inside the case 101, a fastening handle 107 fastened to the center of the case 101, a rotation shaft unit 110 mounted inside the case, and an angle maintaining unit 120 for fixing the angle of the bucket 200. ‘U’-shaped curved portions 106 are formed on both sides of a header body 11, and the bucket 200 for accommodating the decanting kit 2 is rotatably coupled to the curved portions. The angle maintaining unit 120 for fixing the angle of the bucket 200 is provided on both sides with the U-shaped curved portions 106. An upper U-shaped curved portion 106a is formed in the upper case 101a, and a lower U-shaped curved portion 106b is formed in the lower case 101b. In addition, a printed circuit board 103 is provided on the central side of the lower case 101, a through hole 104c through which the driving shaft 302 may pass is provided in the center of the printed circuit board 103, a power adapter mounting port 105a is provided on any one side of the printed circuit board 103, and an LED indicator 105b is provided on the other side of the diagonal line thereof. The battery 140 includes a plurality of mounted rechargeable batteries 141 and a battery fixing unit 142 for fixing the rechargeable batteries 141.

As illustrated in FIGS. 3 to 5, the bucket 200 is mounted on the inside of the U-shaped curved portion 106 (106a, 106b), and in order to maintain the rotation and the angle of the bucket 200, a rotation shaft ( ) and an angle maintaining means 14 are fixedly mounted to the header body 11 of the U-shaped curved portion. Specifically, the fastening handle 107 is fastened to the driving shaft 302 to fix the upper case 101a and the lower case 101b, and the fastening handle 107 is fastened so that the upper case 101a and the lower case 101b are fixed to each other with the case 101. While the fastening handle 107 is fastened to the driving shaft 302, a handle support 108 having a rod formed on the bottom surface thereof so that the case 101 may be fixed connects the upper and lower cases to each other so as to be rotated together. In the center of the upper case 101a and the lower case 101b, shaft through-holes 104a and 104b are formed so as to be inserted and fixed with the driving shaft 302, and a shaft through hole 104c is also provided in the center of the printed circuit board 103 fixedly mounted in the lower case 101b.

The bucket 200 is configured by a bucket body 201 through which the central side is penetrated, a rotation shaft connector 202 formed on both sides of the bucket body 201 and into which the rotation shaft 111 is inserted, a valve stem seating groove 203 for maintaining constantly an angle of the bucket 200 by seating the bucket fixing valve stem 123 of the angle maintaining unit 120, a decanting kit insertion port 204 penetrated through the central side and through which the decanting kit 2 is inserted, a decanting kit holder 205 for hanging the decanting kit inserted through the decanting kit insertion port 204, and a side hole 206 in which a hole is formed so that the center of gravity faces inward.

The driving unit 300 is configured by a motor 301 having the driving shaft 302, a mounting cap 310 fixedly mounted on the upper portion of the motor 301, and a transmission charging module 320 fixed on the upper portion of the mounting cap 310. Specifically, the mounting cap 310 is configured by a cap body 311 having a hole formed in the center, and a flange 312 formed at the lower end of the cap body 311 to be fixed to a housing of the centrifuge. The transmission charging module 320 is configured by a module body 321 and a shaft through hole 322 that is formed in the center and penetrated with the driving shaft 302, and is formed larger than the diameter of the driving shaft 302 so as not to be rotated together. The transmission charging module 320 transmits an induced electromotive force to a reception charging module 130. The transmission charging module 320 and the reception charging module 130 transmit the induced electromotive force from the transmission side to the reception side while maintaining a predetermined interval of about 2 to 3 mm. The reception charging module 130 is fixed to the lower portion of the rotor header 100 to rotate together. When the reception charging module 130 rotates together, the charging amount is not much, but the charging may be performed even during rotation, and the charging is usually performed when the rotation of the rotor stops. In addition, an external power source may be connected through the power adapter mounting port 105a to be charged.

FIG. 6 illustrates that the rotation shaft unit 110 is connected to the bucket 200. The rotation shaft unit 110 includes a rotation shaft 111, a pipe expanding rotation shaft 112 formed in the center of the rotation shaft 111, and an angle limiting groove 113 formed at a predetermined angle with the pipe expanding rotation shaft 112. The pipe expanding rotation shaft 112 is formed integrally with the rotation shaft 111 and is formed by expanding the pipe. This is to form the angle limiting groove 113 on the pipe expanding rotation shaft 112. The rotation shaft 111 is inserted and fixed into the rotation shaft connector 202.

FIG. 7 illustrates the rotation shaft unit 110 and the angle maintaining unit 120 formed in the lower U-shaped curved portion 106b of the lower case 101b. The rotation shaft unit 110 is provided on both sides of the lower case 101b in which the lower U-shaped curved portion 106b is formed. The rotation shaft unit 110 is formed below a pair of support portions 114a and 114b of the rotation shaft 111 and the angle limiting groove 113 together with the structure described above, and a stopper 115 for limiting a rotation angle of the bucket 200 is further configured. Since the stopper 115 is formed below the angle limiting groove 113, the bucket 200 may rotate only by the angle of the angle limiting groove 113.

FIG. 8 illustrates the angle maintaining unit 120. The angle maintaining unit 120 is configured to maintain the bucket 120 at a constant angle. As illustrated in the drawing, the angle maintaining unit 120 includes a first solenoid valve 120a and a second solenoid valve 120b. The first solenoid valve 120a includes a valve body 121a, a valve stem 122a, and a bucket fixing valve stem 123a. The valve body 121a controls the forward and backward movement of the valve stems 122a and 123a. The second solenoid valve 120b includes a valve body 121b and a valve stem 122b. As illustrated in FIG. 8B, when the valve stem of the first solenoid valve 120a moves forward and the bucket fixing valve stem 123a is seated in a valve stem seating groove 202 of the bucket 200, the valve stem 122b of the second solenoid valve 120b moves to the rear of the first solenoid valve stem 122a, and the valve stem 122b of the second solenoid valve 120b prevents the backward of the first solenoid valve stem 122a. That is, in order to prevent the first solenoid valve from malfunctioning or suddenly moving backward, the second solenoid valve 120b is further mounted.

As illustrated in FIG. 9, the decanting kit 2 is configured by a centrifugal container 21, a decanting container 22, and a plotter 23. The centrifugal container 21 is divided into a first chamber 212 in which an appropriate amount of sample for component separation is put and components having a high density among the centrifuged components remain, and a second chamber 211 in which components having a low density are moved from the first chamber 212 to be stored. The second chamber 211 in which the centrifuged components with the low density are moved and stored moves to the decanting chamber 221 of the decanting container 22 therebelow when the bucket 200 is tilted at a certain angle.

FIG. 10 illustrates that the swing rotor assembly 1 of the present invention is mounted on a centrifuge C. In the centrifuge C, the rotor header is rotated by a motor, and operations such as rotation of the motor may be controlled through a monitor formed in front.

The operation of the swing rotor assembly 1 for the centrifuge according to the present invention having the configuration will be described in detail as follows.

First, as illustrated in FIG. 10, the swing rotor assembly 1 of the present invention is accommodated and mounted in the centrifuge C and electrically connected with a controller (not illustrated) of the centrifuge C, and the component separation (centrifugation) of the sample contained in the decanting kit 2 accommodated in the bucket 200 of the rotor header 100 is enabled through horizontal rotation of the rotor header 100 in connection with the device driving according to the operation of centrifuge C.

Here, the user may grasp and move a fastening handle 107 formed at the top of the rotation shaft 302 of the motor 301 in the driving unit 300 for horizontal rotation of the rotor header 100 by hand, so that the swing rotor assembly 1 of the present invention may be easily mounted on or detached from the centrifuge C.

Subsequently, when describing the operation of the swing rotor assembly 1 of the present invention, the decanting kit 2 is inserted into the bucket 200 illustrated in FIG. 6, and in the decanting kit 2, an appropriate amount of sample is injected into the centrifugal container 21 in advance.

When the decanting kit 2 is accommodated in the bucket 200, the motor 301 is driven. The rotor header 100 is rotated by the driving of the motor 301, and accordingly, the sample injected into the decanting kit 2 is centrifuged by the density difference. The centrifuged sample is divided up and down by the density difference, and the plotter 23 is positioned at the boundary line.

When the centrifugation is completed, the bucket 200 is maintained at a predetermined angle by the angle maintaining unit 120, and a desired sample centrifuged on the upper portion of the plotter for a predetermined time is moved from the second chamber 211 of the centrifugal container 21 to the decanting chamber 221 of the decanting container 22.

As a result, the components constituting the sample contained in the decanting kit 2 accommodated and mounted in each of the buckets 200 are separated by the difference in density, respectively. For example, in the case of blood, red blood cells, which are components with the highest density, are concentrated and positioned in the lower portion of the first chamber 211, and buffy coats composed of white blood cells and platelets having the second higher density are concentrated and positioned, and last, the plasma with the lowest density is concentrated and positioned.

When the component separation is completed, the decanting kit 2 is removed, and the sample in the decanting chamber 221 of the decanting kit 2 is extracted.

The above description just illustrates the technical spirit of the present invention and various changes, modifications, and substitutions can be made by those skilled in the art to which the present invention pertains without departing from an essential characteristic of the present invention. Therefore, the embodiments and the accompanying drawings disclosed in the present invention are used to not limit but describe the technical spirit of the present invention and the scope of the technical spirit of the present invention is not limited by the embodiments and the accompanying drawings. The protective scope of the present invention should be construed based on the following claims, and all the techniques in the equivalent scope thereof should be construed as falling within the scope of the present invention.

1. A swing rotor assembly for a centrifuge that is mounted and rotated inside a housing of the centrifuge, the swing rotor assembly comprising:
a driving unit configured by a motor having a driving shaft, a mounting cap mounted on the upper portion of the motor and provided with a flange at the lower end, and a transmission charging module fixed on the mounting cap to wirelessly charge the battery;
a rotor header including a case in which U-shaped curved portions are formed on both sides for mounting a bucket while being mounted and rotated on a motor driving shaft, an angle maintaining unit which is mounted inside the case to control an angle of the bucket and discharge a centrifuged sample, a battery mounted inside the case to drive the angle maintaining unit, a reception charging module mounted on the bottom of the case to wirelessly charge the battery, and a rotation shaft unit mounted inside the case and rotatably supported at both sides of the bucket; and
a bucket mounted on the rotation shaft unit and rotating up and down by a centrifugal force while rotating together with the rotor header.

2. The swing rotor assembly for the centrifuge of claim 1, wherein the angle maintaining unit is configured by a first solenoid valve having a front-rear movement valve shaft that moves forward and backward to fix the position of the bucket so that the bucket is maintained to be inclined at a predetermined angle by a centrifugal force, and a second solenoid valve having a left-right movement valve shaft to fix the valve shaft of the first solenoid to the rear side so as to prevent malfunction or sudden backward of the first solenoid valve.

3. The swing rotor assembly for the centrifuge of claim 1, wherein the rotation shaft unit is configured by a pair of rotation shaft supports mounted inside the case, a rotation shaft supported by the pair of rotation shaft supports, a pipe extending rotation shaft formed between the pair of supports by extending the rotation shaft, an angle limiting groove formed on the pipe extending rotation shaft to limit the bucket at a constant rotational angle, and a stopper formed below the angle limiting groove to limit the rotational angle of the angle limiting groove.

4. The swing rotor assembly for the centrifuge of claim 1, wherein a power adapter through hole is further formed above the case, and a power adapter connector into which an adapter is inserted through the power adapter through hole and mounted is further formed inside the case.

5. The swing rotor assembly for the centrifuge of claim 1, wherein a light transmission hole is further formed above the case, and an LED indicator for checking whether power is connected and whether power is charged is further provided inside the case to check whether the power is connected or the power is charged through a light source emitted through the light transmission hole.

6. The swing rotor assembly for the centrifuge of claim 1, wherein the transmission charging module and the reception charging module are wirelessly connected to each other, so that an induced electromotive force is transmitted from the transmission charging module to the reception charging module to be charged.
